(19) United States
(12) Patent Application Publication
(10) Pub. No.: US 2010/0326839 A1
(43) Pub. Date: Dec. 30, 2010

(54) METHOD FOR ANODIZING ALUMINUM PIPE FOR BASE OF PHOTOCONDUCTOR DRUM, AND BASE OF PHOTOCONDUCTOR DRUM

(75) Inventors: Takuya Morikawa, Oyama-shi (JP); Masaaki Ohide, Oyama-shi (JP)

Correspondence Address: Showa Denko K.K.;c/o Keating & Bennett, LLP, 1800 Alexander Bell Drive, Suite 200, Reston, VA, 20191, US

(73) Assignee: SHOWA DENKO K.K., Minato-ku, Tokyo (JP)

(21) Appl. No.: 12/741,661

(22) PCT Filed: Nov. 5, 2008
(86) PCT No.: PCT/JP2008/070080

§ 371 Date: Sep. 3, 2010

(30) Foreign Application Priority Data
Nov. 8, 2007 (JP) 2007-290825

(51) Int. Cl. C25D 11/04; G03G 15/00

(52) U.S. Cl. 205/324; 399/159; 205/325

(57) ABSTRACT

An anodizing method of the present invention is characterized in that in a state in which an outer peripheral surface of an aluminum pipe 2 for a photoconductor drum substrate is in contact with an electrolysis solution, a high-frequency voltage of 5 kHz or higher is applied to the electrolysis solution to conduct electrolysis to thereby form an anodic oxide film on the outer peripheral surface of the aluminum pipe 2. With this method, an anodic oxide film can be formed on the surface of the pipe, and an aluminum pipe free from burr-shaped convex defects can be produced. Furthermore, the anodizing for forming an anodic oxide film can be carried out at a higher rate, and an anodic oxide film with less electrolyte elution can be formed.

### TECHNICAL FIELD

The present invention relates to an anodizing method for producing an aluminum pipe excellent in surface quality for use as a substrate of an OPC photoconductor drum for electrophotographic devices, such as, e.g., copiers, printers, and facsimile devices, and a photoconductor drum substrate excellent in surface quality obtained by the anodization method.

In the present specification and claims, the language of “aluminum” is used to include the meaning of aluminum and its alloys.

Further, in the present specification and claims, the language of “electrolysis waveform” is a control factor selected from an electrical current and a voltage, and means an output waveform of the control factor for the control during electrolytic processing.

### BACKGROUND ART

An aluminum pipe used as a photoconductor drum substrate for electrophotographic devices, such as, e.g., copiers, printers, and facsimile devices, is required to have a near-mirror finished surface state since it is required to form an uniform OPC (organic photoconductor) coating film on a surface of the aluminum pipe.

Conventionally, an aluminum pipe was subjected to cutting to perform mirror finish, but the adjustments and management of the cutting tools were not easy and skilled operation is required. Therefore, there was a problem that it was unsuitable for mass production.

Under the circumstances, in recent years, an uncut pipe, such as, e.g., a DI pipe obtained by subjecting a rolled aluminum sheet to ironing, an EI pipe obtained by subjecting an aluminum extruded raw pipe to ironing, or an ED pipe obtained by subjecting an aluminum extruded raw pipe to drawing, has become more popular as a photoconductor drum substrate. Among them, differently from other uncut pipes, in the case of an ED pipe, it is possible to produce more than ten pipes through single processing (two drawing steps), which is suitable for mass production. Therefore, it has been receiving attention as a product capable of coping with mass consumption in accordance with market expansion.

Generally, an ED pipe is manufactured by: obtaining an aluminum extruded raw pipe by extruding an aluminum billet; then cutting the extruded raw pipe into a predetermined length; drawing the cut pipe to obtain an aluminum pipe having an outer diameter, an inner diameter, and a thickness of the pipe wall each regulated to respective values; and then subjecting it to cutting, chamfering of the edge portion, and cleansing in order, followed by inspection of the dimension and appearance thereof.

A photoconductor drum substrate made of the aforementioned ED pipe is required to have high surface smoothness and dimensional accuracy. Due to the uncut processing, however, the substrate has minute surface defects, such as, e.g., scale-shaped defects due to die lines generated during the extrusion processing and oil pits generated by lubricating oil pushed in during the drawing processing.

In particular, scale-shaped surface defects 92 occurred during the drawing process of an extruded raw pipe having minute aluminum pieces 91 adhering to its surface often rise up by ultrasonic cleaning and/or effects of heat during the OPC coating to cause burr-shaped convex defects 93 (see FIG. 5). The existence of such burr-shaped convex defects 93 on the surface of the photoconductor drum substrate causes such problems that the burr-shaped convex defects 93 often become origins of leakages (electric leakages) at the time of uniformly charging the drum substrate constituting a photoconductor drum, resulting in image deterioration.

As a technology to prevent generation of such burr-shaped convex defects, there is a know method in which an aluminum extruded raw pipe is manufactured by performing extrusion processing using an extruding die in which the relationship between the center line average roughness Ra (Y) of a bearing portion of an extruding die in the peripheral direction thereof and the center line average roughness Ra (X) thereof in the extrusion direction is set to Ra (Y)<Ra (X), to control the adhesion (occurrence) of minute aluminum pieces on the extruded raw pipe surface which causes burr-shaped convex defects (see Patent Document 1). This method can control generation of burr-shaped convex defects on the ED pipe surface, but burr-shaped convex defects occur on rare occasions, and thus generation of burr-shaped convex defects could have not been prevented sufficiently.

Patent Document 1: Japanese Unexamined Laid-opened Patent Application Publication No. H08-267122

### DISCLOSURE OF THE INVENTION

### Problem to be Solved by the Invention

The present inventors have conceived to form an anodic oxide film on a surface of an aluminum pipe so that even in cases where scale-shaped surface defects, which may be generated during the drawing processing of an extruding raw pipe having minute aluminum pieces adhering to its surface, are generated, such scale-shaped surface defects are prevented from rising up by subsequent ultrasonic cleaning and/or effects of heat during OPC coating. In other words, the inventors have conceived to harden a surface of an aluminum drawn pipe (ED pipe) including scale-shaped surface defects by forming an anodic oxide film to prevent burr-shaped convex defects from raising up to thereby assuredly prevent generation of burr-shaped convex defects.

Although such anodic oxide film is formed by anodizing, it is strongly required that such anodizing be performed as cheaply as possible.

The anodization of an aluminum member is generally carried out by immersing the aluminum member and an opposite pole plate in an electrolysis solution in an electrolytic tank and applying electric current with the aluminum member as an anode and the opposite pole plate as a cathode. However, the formation rate of the film is slow and the process takes a long time, resulting higher anodizing cost.

Furthermore, a photoconductor drum substrate made of an ED pipe is mass-produced in a continuous manner and therefore the anodizing device should be a device capable of easily being incorporated in a production line flow. In other words, it must be a device capable of processing at a high rate in accordance with the flow of the production line. However, conventionally available anodizing methods were unable to meet such high-speed demand.

Furthermore, in general, formation of an anodic oxide film with a conventional anodizing method requires the use of a high concentration electrolysis solution. In this case, the electrolyte (ion species) remained in the formed anodic oxide film easily elutes to the OPC side after the OPC coating, causing carrier injection by the ion in the OPC layer, which results in image deterioration.

The present invention was made in view of the aforementioned technical background, and aims to provide a method for anodizing an aluminum pipe for a photoconductor drum substrate, wherein the method is capable of producing an aluminum pipe with no burr-shaped convex defect by forming an anodic oxide film on a surface of the pipe, capable of performing anodization for forming the film at a higher rate, and also capable of forming the anodic oxide film with less elution of residual electrolyte. The present invention also aims to provide a photoconductor drum substrate excellent in surface quality with no burr-shaped convex defect and capable of forming a high-quality image.

### Means for Solving the Problems

The present invention provides the following means.

[1] A method for anodizing an aluminum pipe for a photoconductor drum substrate, characterized in that

in a state in which an outer peripheral surface of an aluminum pipe for a photoconductor drum substrate is in contact with an electrolysis solution, a high-frequency voltage of 5 kHz or higher is applied to the electrolysis solution to conduct electrolysis to thereby form an anodic oxide film on the outer peripheral surface of the aluminum pipe.

[2] The method for anodizing an aluminum pipe for a photoconductor drum substrate as recited in the aforementioned Item [1], wherein a negative component voltage of the high-frequency voltage is set to 0V at the time of applying the high-frequency voltage.

[3] The method for anodizing an aluminum pipe for a photoconductor drum substrate as recited in the aforementioned Item [2], wherein a negative voltage applied rate calculated by dividing an applied time of the negative component voltage in one cycle by a total cycle time is 0.05 to 0.8 when the high-frequency voltage is applied.

[4] The method for anodizing an aluminum pipe for a photoconductor drum substrate as recited in the aforementioned Item [2] or [3], wherein the negative component voltage is output using a short-circuit when the high-frequency voltage is applied.

[5] The method for anodizing an aluminum pipe for a photoconductor drum substrate as recited in any one of the aforementioned Items [1] to [4], wherein an electrolytic waveform the high-frequency voltage during the electrolysis is a rectangular wave.

[6] The method for anodizing an aluminum pipe for a photoconductor drum substrate as recited in any one of the aforementioned Items [1] to [5], wherein an electrolysis solution containing at least one of acids selected from the group consisting of sulfuric acid, phosphoric acid, and oxalic acid is used as the electrolysis solution.

[7] The method for anodizing an aluminum pipe for a photoconductor drum substrate as recited in any one of the aforementioned Items [1] to [6], wherein

the electrolysis is performed by bringing the outer peripheral surface of the aluminum pipe into contact with the electrolysis solution by immersing the aluminum pipe in the electrolysis solution in an electrolytic tank and performing at least one of temperature regulation and concentration regulation of the electrolysis solution in the electrolytic tank.

[8] The method for anodizing an aluminum pipe for a photoconductor drum substrate as recited in any one of the aforementioned Items [1] to [7], wherein as the aluminum pipe, a pipe made of one of materials selected from the group consisting of Al—Mn series alloy, Al—Mg series alloy, Al—Mg—Si series alloy, and pure aluminum.

[9] A photoconductor drum substrate made of an aluminum pipe obtained by anodizing according to the anodizing method as recited in any one of the aforementioned Items [1] to [8].

[10] The photoconductor drum substrate as recited in the aforementioned Item [9], wherein a relational expression of (T−W)≧50 is satisfied,

where “T” is micro-Vickers hardness MHv of the surface of the aluminum pipe having the anodic oxide film, and “W” is micro-Vickers hardness MHv of the surface of the aluminum pipe having an anodic oxide film formed by conducting electrolysis under the same electrolysis conditions except that direct voltage was applied.

### EFFECTS OF THE INVENTION

According to the invention described in the aforementioned item [1], an anodic oxide film can be formed on the outer peripheral surface of the aluminum pipe by the anodization and the formation of such anodic oxide film hardens the outer peripheral surface of the aluminum pipe, which prevents the scale-shaped surface defects from rising up (in other words, no burr-shaped convex defect will be formed). Therefore, even if, for example, ultrasonic irradiation for cleaning and/or heating for OPC coating is conducted, formation of burr-shaped convex defects can be prevented sufficiently. Consequently, the aluminum pipe manufactured by the anodizing method of the present invention has no burr-shaped convex defect and is excellent in surface quality, which hardly causes leakage when a photoconductor drum constituted by the aluminum pipe as a substrate is uniformly charged.

Also, a high-frequency voltage of 5 kHz or higher is applied to the electrolysis solution to conduct electrolysis, which improves the formation rate of the anodic oxide film. Since anodization can be performed at a higher rate (anodization can be performed at a higher process efficiency), it is possible to incorporate the process in a continuous production line (anodization can be conducted in-line).

Furthermore, since the electrolysis is conducted by applying a high-frequency voltage of 5 kHz or higher, as compared with the case in which electrolysis is performed with a high-frequency voltage of below 5 kHz, a harder anodic oxide film can be formed and that the amount of eluted electrolyte eluted from the anodic oxide film can be decreased (that is, the effects due to elution of residual ions in the anodic oxide film can be eliminated).

In the invention described in the aforementioned item [2], the negative component voltage of the high-frequency voltage at the time of applying the high-frequency voltage is 0V, which enables faster anodization.

In the invention described in the aforementioned item [3], a negative voltage applied rate calculated by dividing an applied time of the negative component voltage in one cycle by a total cycle time is 0.05 to 0.8 when the high-frequency voltage is applied, and therefore anodization can be conducted at a faster rate.

In the invention described in the aforementioned item [4], a short circuit is used instead of a negative power source, and therefore the omission of the negative side power source can reduce the equipment cost, enabling anodization at lower cost.

In the invention described in the aforementioned item [5], since the electrolysis waveform for the electrolysis at the high-frequency voltage is rectangular, anodization can be conducted at a faster rate.

In the invention described in the aforementioned item [6], the film formation rate of the anodic oxide film can be improved.

In the invention described in the aforementioned item [7], the electrolysis is conducted while performing at least one of the temperature regulation and the concentration regulation to the electrolysis solution, and therefore variations of the film formation rate and the film quality can be controlled.

In the invention described in the aforementioned item [8], as the aluminum pipe, since a pipe made of one of the materials selected from the group consisting of Al—Mn series alloy, Al—Mg series alloy, Al—Mg—Si series alloy, and pure aluminum, the film formation rate of the anodic oxide film can be improved and the film quality of the anodic oxide film can be equalized.

The photoconductor drum substrate according to the present invention as described in the aforementioned item [9] has essentially no burr-shaped convex defect on its outer peripheral surface, and therefore the photoconductor drum with a photoconductor layer (OPC, etc.) coated on the outer peripheral surface of the photoconductor drum substrate hardly causes leakages when uniformly charged. Also, since in-line anodization can be performed, the production cost can be lowered.

In the photoconductor drum substrate according the invention as described in the aforementioned item [10], since the relational expression of (T−W) is satisfied, formation of burr-shaped convex defects can be prevented sufficiently.

### BRIEF DESCRIPTION OF DRAWINGS

FIG. 1 is a schematic view showing an example of an anodizing device used for the anodizing method according to the present invention.

FIG. 2 is a view showing an example of a circuit configuration of the power source, wherein FIG. 2(a) is a circuit structural diagram equipped with a positive side power source and a negative side power source, and FIG. 2(b) is a circuit structural diagram equipped with a positive side power source and a short circuit.

FIG. 3 is a waveform graph showing the electrolysis waveform of the applied voltage used in Example 1.

FIG. 4 is a waveform graph showing the electrolysis waveform of the applied voltage used in Example 6.

FIG. 5 is an explanatory view for explaining the generation process of burr-shaped convex defects.

### DESCRIPTION OF THE REFERENCE NUMERALS

1: anodizing device

2: aluminum pipe

4: electrolytic tank

6: electrolysis solution

11: temperature regulator

12: concentration regulator

### BEST MODE FOR CARRYING OUT THE INVENTION

A method for anodizing an aluminum pipe for a photoconductor drum substrate according to the present invention is characterized in that electrolysis is carried out by applying a high-frequency voltage of 5 kHz or higher to an electrolysis solution in a state in which an outer peripheral surface of the aluminum pipe for the photoconductor drum substrate is in contact with the electrolysis solution.

By conducting the aforementioned electrolysis, an anodic oxide film can be formed on the outer peripheral surface of the aluminum pipe and the formation of the anodic oxide film hardens the outer peripheral surface of the aluminum pipe. This prevents scale-shaped surface defects from rising up (in other words, burr-shaped convex defects will not be generated). Therefore, even if ultrasonic irradiation for cleaning and/or heating for OPC coating, etc., is conducted after the anodization, formation of burr-shaped convex defects can be prevented effectively. Consequently, in the aluminum pipe manufactured by the anodizing method of the present invention, essentially no burr-shaped convex defect exists on the outer peripheral surface and it is excellent in surface quality. As a result, leakage hardly occurs when a photoconductor drum constituted by the aluminum pipe as a substrate is uniformly charged. In this disclosure, “essentially no burr-shaped convex defect exists on the outer peripheral surface” means that, in a state in which an OPC film is formed on the outer peripheral surface of the aluminum pipe, there are no burr-shaped convex portion (defective portion) protruded outwardly than the surface of the OPC coating.

Since the electrolysis is conducted by applying a high-frequency voltage of 5 kHz or higher to an electrolysis solution, the formation rate of the anodic oxide film can be improved. As described above, since the anodization can be performed at a higher rate, it is possible to employ the processing method of the present invention in a continuous production line (i.e., anodization can be conducted in-line).

Furthermore, since the electrolysis is conducted by applying a high-frequency voltage of 5 kHz or higher, as compared with electrolysis conducting by applying a high-frequency voltage of below 5 kHz, a harder anodic oxide film can be formed and the amount of eluted electrolyte eluted from the anodic oxide film can be decreased (which in turn can prevent image deterioration due to elution of residual ions).

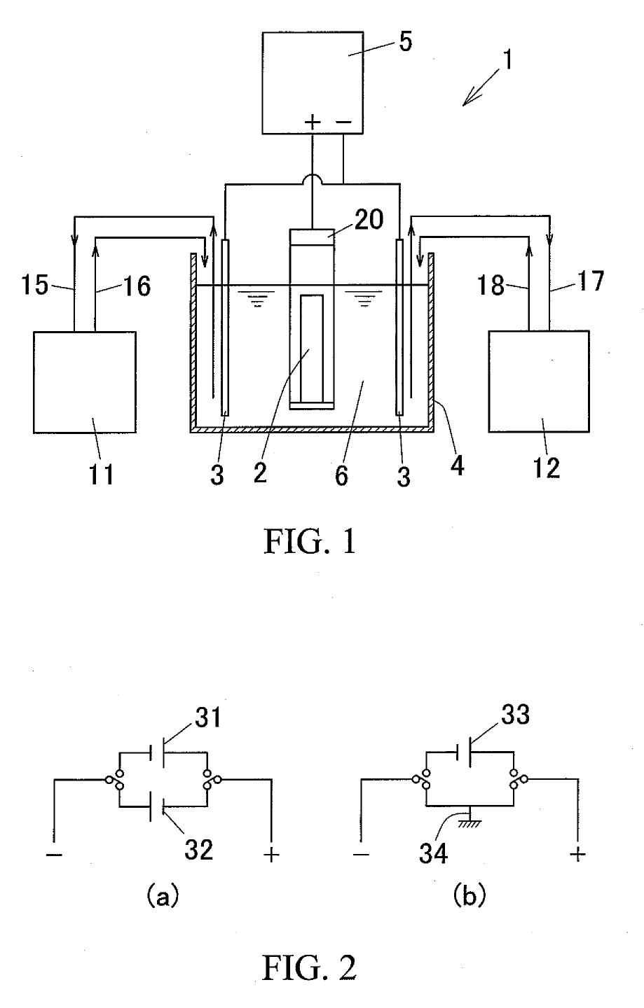

An embodiment of an anodizing device 1 used for the anodization method of the present invention is shown in FIG. 1. In FIG. 1, the reference numeral “4” denotes an electrolytic tank, “5” denotes a power unit, “11” denotes a temperature regulator, and “12” denotes a concentration regulator.

The electrolysis solution 6 is filled in the electrolytic tank 4. Further, an electrolytic frame 20 is fixed in a suspended state at the center portion in the electrolytic tank 4. An aluminum pipe 2 is disposed on the bottom plate of the electrolytic frame 20 in a vertically standing manner. The aluminum pipe 2 is disposed so that the entirety thereof is immersed in the electrolysis solution 6 in the electrolytic tank 4. Also, in the electrolytic tank 4, a pair of right and left opposed electrodes 3 and 3 are disposed on both sides of the aluminum pipe 2 so as not to contact the aluminum pipe 2. These opposed electrodes 3 and 3 are disposed so that the large part thereof is immersed in the electrolysis solution 6 in the electrolytic tank 4.

The anode (+pole) of the power unit 5 is connected to the aluminum pipe 2 via the electrolytic frame 20, and the cathodes (−poles) of the power unit 5 are connected to the electrodes 3 and 3. Thus, by conducting electrolysis by applying a high-frequency voltage of 5 kHz or higher from the power unit 5 to the electrolysis solution 6, an anodic oxide film is formed on the outer peripheral surface of the aluminum pipe 2.

As the aluminum pipe 2 (anodizing targeted aluminum pipe), a drawn aluminum pipe for a photoconductor drum substrate obtained by drawing an aluminum extruded raw pipe (aluminum ED pipe for a photoconductor drum substrate) can be exemplified.

The temperature regulator 11 is a device for regulating the temperature of the electrolysis solution 6. In other words, the temperature regulator 11 is configured to introduce the electrolysis solution 6 in the electrolytic tank 4 via a liquid suction pipe 15, regulate the temperature of the solution 6, and then return the temperature regulated electrolysis solution 6 to the electrolytic tank 4 via a return pipe 16.

The concentration regulator 12 is a device for regulating the concentration of the electrolysis solution 6. In detail, the concentration regulator 12 is configured to introduce the electrolysis solution 6 in the electrolytic tank 4 via a liquid suction pipe 17, regulate the concentration of the electrolysis solution 6, and then return the concentration regulated electrolysis solution 6 to the electrolytic tank 4 via a return pipe 18.

By using the temperature regulator 11 and the concentration regulator 12, the temperature and concentration of the electrolysis solution 6 in the electrolytic tank 4 can be keep constant, respectively, which in turn can control variation of the formation rate of the anodic oxide film and the film quality thereof.

In the anodizing method of the present invention, the electrolysis is performed by applying a high-frequency voltage of 5 kHz or higher to the electrolysis solution. It is preferable to conduct the electrolysis by applying a high-frequency voltage of 6 to 30 kHz, more preferably 10 to 15 kHz.

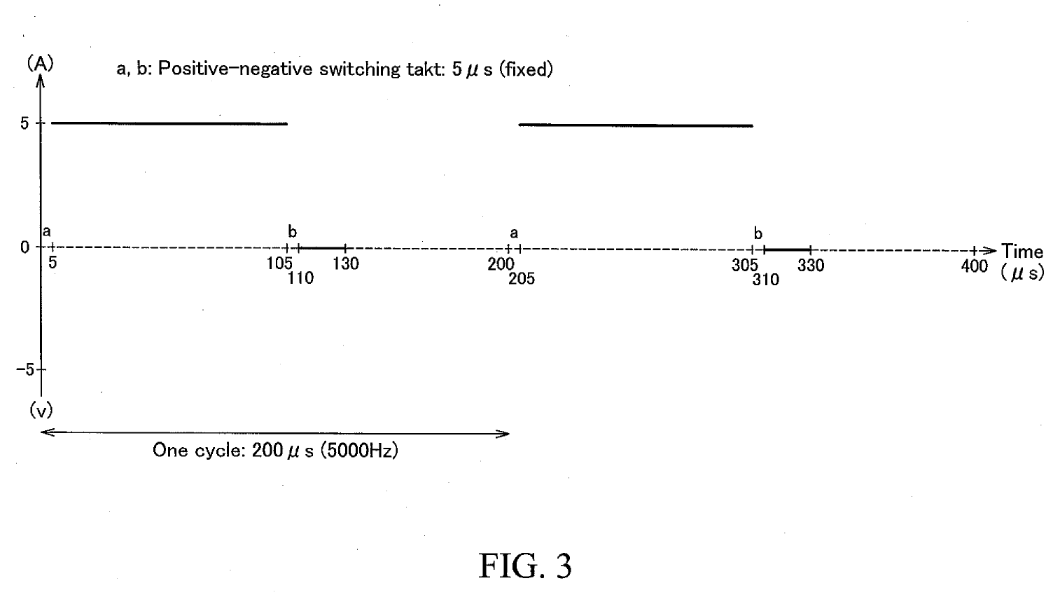

In conducting the electrolysis, it is preferable to set the negative component voltage to 0V at the time of applying the high-frequency voltage. In this case, there is an advantage that anodization can be executed at a higher rate. For example, as shown in the electrolysis waveform graph in FIG. 3, it is preferable to set the negative component voltage to 0V at the time of applying a high-frequency voltage.

Furthermore, when setting the negative component voltage to 0V at the time of applying a high-frequency voltage, the negative component voltage at the time of applying the high-frequency voltage is preferably output using a short circuit. In other words, it is preferable to use a circuit configuration having, e.g., a positive power source 33 and a short circuit 34 as shown in FIG. 2(b). By using such a short circuit 34, a negative power source can be eliminated to thereby reduce the equipment cost.

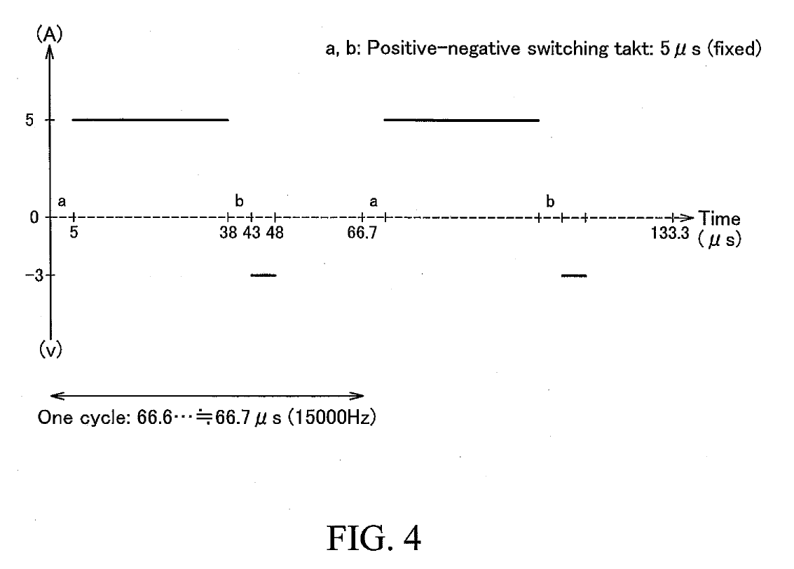

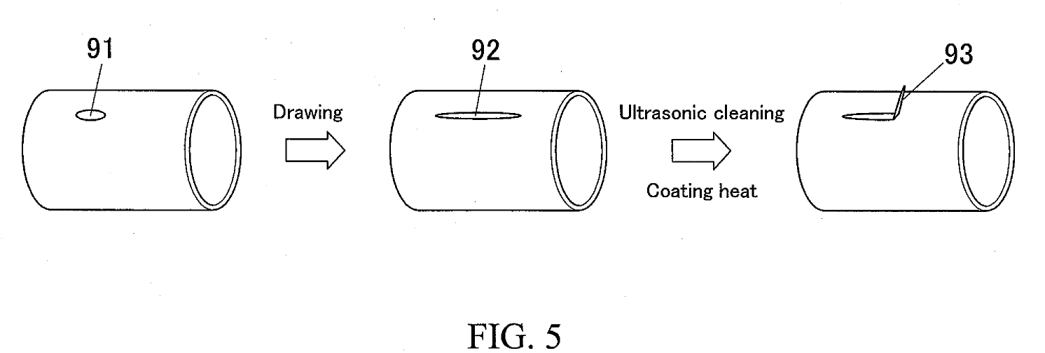

Also, when setting the negative component voltage to a voltage below 0V (negative voltage) at the time of applying a high-frequency voltage (see, e.g., FIG. 4), for example, as shown in FIG. 2(a), a circuit configuration having a positive power source 31 and a negative power source 32 can be used.

The electrolysis waveform for the electrolysis using a high-frequency voltage is not specifically limited, and can be, for example, a rectangular wave, a sine wave, or a triangular wave. Among other things, it is preferable that the electrolysis waveform is a rectangular wave (for example, see FIGS. 3 and 4) which can conduct anodization at a higher rate.

The electrolysis solution 6 is not specifically limited, but it is preferable to use an electrolysis solution containing at least one of acids selected from the group consisting of sulfuric acid, phosphoric acid, and oxalic acid. Among other things, it is specifically preferable to use an electrolysis solution 6 containing a sulfuric acid as a main component, which can further enhance the film formation rate of the anodic oxide film.

As the aluminum pipe 2, a pipe made of Al—Mn series alloy, Al—Mg series alloy, Al—Mg—Si series alloy, or pure aluminum can be preferably used, but not limited to them, from the view point of improving the film formation rate of the anodic oxide film and equalizing the film quality.

The aluminum pipe manufactured by the anodizing method of the present invention has essentially no burr-shaped convex defect on its outer peripheral surface and is excellent in surface quality, and it is preferable to satisfy the relational expression of

(T−W)≧50,

where “T” is micro-Vickers hardness MHv of the surface of the aluminum pipe having an anodic oxide film, and “W” is micro-Vickers hardness MHv of the surface of the aluminum pipe having an anodic oxide film formed by conducting electrolysis with the same electrolysis conditions except that direct voltage was applied. When (T−W) is 50 or above, formation of burr-shaped convex defects can be prevented sufficiently, which enables to provide an aluminum pipe for a photoconductor drum substrate more excellent in surface quality.

Furthermore, it is preferable to satisfy the relational expression of

(X−Y)/Y≦2/3,

where “X” is an amount of eluted electrolyte of the aluminum pipe having an anodic oxide film formed by electrolysis by applying a high-frequency voltage of 5 kHz or higher, and “Y” is an amount of eluted electrolyte of an aluminum pipe having an anodic oxide film formed by electrolysis under the same electrolysis conditions except that direct voltage was applied. In cases where the aforementioned relational expression is satisfied, the amount of eluted electrolyte eluted from the anodic oxide film can be decreased sufficiently, in other words, the effects to the quality (image deterioration) caused by the elution of residual ions in the anodic oxide film to the OPC (organic photoconductor) side can be removed sufficiently, and therefore a long-term quality stability for a photoconductor drum substrate can be achieved.

### Examples

Next, although embodiments of the present invention will be explained, it should be understood that the present invention is not especially limited to these embodiments.

### Example 1

An aluminum drawn pipe (aluminum ED pipe) 2 obtained by drawing an aluminum extruded raw pipe made of A3003 material was set on the anodizing device 1 shown in FIG. 1 to conduct electrolysis to thereby form an anodic oxide film on the outer peripheral surface of the aluminum drawn pipe 2. Thus, an aluminum pipe for a photoconductor drum substrate was obtained. Using a power source equipped with both a positive power source 33 and a short circuit 34 as shown in FIG. 2(b) as a power source 5 and using a sulfuric acid aqueous solution of 30 mass % concentration as the electrolysis solution 6, the electrolysis was conducted by applying a high-frequency voltage of 5,000 Hz (5 kHz) having a rectangular electrolysis waveform as shown in FIG. 3 while controlling the temperature of the electrolysis solution 6 to 5° C. Constant current electrolysis was conducted on the positive side and constant voltage electrolysis was conducted on the negative side (see FIG. 3). At the time of the electrolysis, the positive current density was 5 A/dm², the positive voltage applied ratio was 0.5, the negative voltage was 0V, and the negative voltage applied ratio was 0.1. Thus, an anodic oxide film of 27 μm was formed by conducting electrolysis for 20 minutes.

The positive voltage applied ratio is a value (ratio) calculated by dividing the positive voltage applied time in one cycle by the cycle time. On the other hand, the negative voltage applied ratio is a value (ratio) calculated by dividing the negative voltage applied time in one cycle by the cycle time.

### Examples 2-7>

Aluminum pipes for photoconductor drum substrates were obtained in the same manner as in Example 1 except that the electrolysis conditions were set to the values shown in Table 1. In Examples 6 and 7, as a power source 5 of the anodizing device 1, a power source equipped with the positive side power source 31 and the negative side power source 32 as shown in FIG. 2(a) was used.

### Comparative Examples 1-5>

Aluminum pipes for photoconductor drum substrates were obtained in the same manner as in Example 1 except that the electrolysis conditions were set to the values shown in Table 1.

### Comparative Examples 6 and 7>

Aluminum pipes for photoconductor drum substrate were obtained in the same manner as in Example 1 except that electrolysis was conducted by applying direct current (DC) voltage under the electrolysis conditions shown in Table 1.

The electrolysis time, the thickness of the formed anodic oxide film, the film formation rate, the micro-Vickers hardness (MHv) of the surface of the aluminum pipe obtained by anodization, and the increase rate of the eluted amount of the electrolyte (X−Y)/Y in each of Examples and Comparative Examples are shown in Table 1.

The micro-Vickers hardness (MHv) is a value measured with a test load of 5 gf using a hardness tester (product of Akashi Seisakusho: Micro-Vickers type MVK-G2).

Furthermore, “the amount of eluted electrolyte of the aluminum pipe having an anodic oxide film” denotes a value measured by the following method. That is, first, an extra pure water was put in a container and the electrical conductivity (μS/m) of this extra pure water was measured to obtain the measured value M. Next, the container was heated to boil the extra pure water. On the other hand, the aluminum pipe for a photoconductor drum substrate (aluminum pipe in which anodic oxide film was formed) was washed with running water, then immersed in extra pure water to clean. This aluminum pipe was immersed in the boiling extra pure water and boiled under this condition for 60 minutes. This boiling caused elution of electrolyte in the anodic oxide film. Next, the aluminum pipe was removed from the container, the extra pure water in the container was cooled to a room temperature, and the electrical conductivity (μS/m) of the extra pure water was measured to obtain the measured value N. The value obtained by the formula (N−M) was the “amount of eluted electrolyte of the aluminum pipe in which an anodic oxide film was formed”.

TABLE 1

| | | | | | | Sulfuric | | | | | | |
|---|---|---|---|---|---|---|---|---|---|---|---|---|
| | | | | | | acid | | | | | | |
| | | | | | | concen- | | | | | Amount of eluted | |
| | Frequency | | | | | tration of | | | | | electrolytes | |
| | of high- | Positive | Positive | | Negative | elec- | Elec- | | Film | Micro- | Increased | |
| | frequency | current | voltage | Negative | voltage | trolysis | trolysis | Film | formation | Vickrs | amount | Increased |
| | voltage | density | applied | voltage | applied | solution | time | thickness | rate | hardness | X − Y | ratio |
| | (Hz) | (A/dm²) | ratio | (V) | ratio | (mass %) | (min) | (μm) | (μm/min) | (MHv) | (μS/m) | (X − Y)/Y |
| Comp. Ex. 1 | 100 | 5 | 0.5 | 0 | 0.1 | 30 | 20 | 26 | 1.30 | — | 9.8 | 0.65 |
| Comp. Ex. 2 | 500 | 5 | 0.5 | 0 | 0.1 | 30 | 20 | 21 | 1.05 | — | 9.0 | 0.60 |
| Comp. Ex. 3 | 1,000 | 5 | 0.5 | 0 | 0.1 | 30 | 20 | 15 | 0.75 | — | 8.4 | 0.56 |
| Ex. 1 | 5,000 | 5 | 0.5 | 0 | 0.1 | 30 | 20 | 27 | 1.35 | — | 7.9 | 0.53 |
| Ex. 2 | 10,000 | 5 | 0.5 | 0 | 0.1 | 30 | 20 | 30 | 1.50 | — | 7.5 | 0.50 |
| Ex. 3 | 15,000 | 5 | 0.5 | 0 | 0.1 | 30 | 20 | 31 | 1.55 | — | 7.4 | 0.49 |
| Comp. Ex. 4 | 100 | 5 | 0.5 | 0 | 0.1 | 30 | 16 | 20 | 1.25 | 210 | — | — |
| Comp. Ex. 5 | 1,000 | 5 | 0.5 | 0 | 0.1 | 30 | 25 | 20 | 0.80 | 244 | — | — |
| Ex. 4 | 15,000 | 5 | 0.5 | 0 | 0.1 | 30 | 13 | 20 | 1.54 | 257 | — | — |
| Ex. 5 | 15,000 | 5 | 0.5 | 0 | 0.1 | 5 | 20 | 10 | 0.50 | — | 3.5 | — |
| Ex. 6 | 15,000 | 5 | 0.5 | −3 | 0.1 | 5 | 20 | 5 | 0.28 | — | 12.4 | — |
| Ex. 7 | 15,000 | 5 | 0.5 | −5 | 0.1 | 5 | 20 | 3 | 0.15 | — | 20.3 | — |
| Comp. Ex. 6 | DC | 1 | 1 | | | 30 | 20 | 7 | 0.35 | — | 14.0 | — |
| | (direct | | | | | | | | | | | |
| | current) | | | | | | | | | | | |
| Comp. Ex. 7 | DC | 3 | 1 | | | 30 | 20 | 20 | 1.00 | 180 | 15.0 | — |
| | (direct | | | | | | | | | | | |
| | current) | | | | | | | | | | | |

In Table 1, by comparing Examples 1 to 4 with Comparative Examples 1 to 5 which were the same in electrolysis conditions except for the frequency of the high-frequency voltage, it is understood that the film formation rate has been improved in Examples 1 to 4 in which electrolysis was conducted with a high-frequency voltage of 5,000 Hz (5 kHz) or higher, as compared with Comparative Examples 1 to 5 in which electrolysis was conducted with a high-frequency voltage of lower than 5,000 Hz. In this way, by conducting electrolysis while applying a high-frequency voltage of 5,000 Hz (5 kHz) or higher, an anodic oxide film can be formed at a higher rate.

Furthermore, by comparing Example 4 with Comparative Examples 4 and 5, it is understood that the Vickers hardness value has been increased in Example 4 in which electrolysis was conducted by applying a high-frequency voltage of 5,000 Hz (5 kHz) or higher, as compared with Comparative Examples 4 and 5 in which electrolysis was conducted by applying a high-frequency voltage of lower than 5,000 Hz. Thus, by conducting electrolysis by applying a high-frequency voltage of 5,000 HZ or higher, the Vickers hardness value of the surface of the obtained aluminum pipe can be increased.

Furthermore, from the data of the frequency and film formation rate in Comparative Examples 1 to 3 and Examples 1 to 4, it is understood that although the film formation rate once decreases as the frequency conditions increase from 100 Hz to 1,000 Hz, the film formation rate again increases significantly with a minimal point of 1,000 Hz as the frequency condition increases from 1,000 Hz to 15,000 Hz.

Furthermore, by comparing Examples 5 to 7 with each other, which were the same in electrolysis conditions except for the negative voltage values, it is understood that the film formation rate has been improved significantly in Example 5 in which electrolysis was conducted by setting the negative voltage (voltage of the negative component) to 0V, as compared with Example 6 in which the negative voltage was set at −3V and Example 7 in which the negative voltage was set at −5V. Therefore, it is preferable that the voltage of the negative component is set to 0V at the time of applying a high-frequency voltage.

In addition, in Example 5 in which electrolysis was conducted by setting the negative voltage (voltage of the negative component) to 0V, the increased amount (X−Y) of the eluted electrolyte was decreased significantly, as compared with Example 6 in which the negative voltage was set to −3V and Example 7 in which the negative voltage was set to −5V and therefore the amount of eluted electrolyte eluted from the anodic oxide film can be decreased sufficiently (in other words, image deterioration phenomenon due to elution of residual ions in the anodic oxide film to the OPC side can be prevented sufficiently). From this point of view, it is preferable that the voltage of the negative component is set to 0V at the time of applying a high-frequency voltage.

This application claims priority to Japanese Patent Application No. 2007-290825 filed on Nov. 8, 2007, and the entire disclosure of which is incorporated herein by reference in its entirety.

It should be understood that the terms and expressions used herein are used for explanation and have no intention to be used to construe in a limited manner, do not eliminate any equivalents of features shown and mentioned herein, and allow various modifications falling within the claimed scope of the present invention.

### INDUSTRIAL APPLICABILITY

An aluminum pipe manufactured using the anodizing method of the present invention is excellent in surface quality and therefore can be used as a photoconductor drum substrate for an electrophotographic device, such as, e.g., a copier, a printer, or a facsimile device.

1. A method for anodizing an aluminum pipe for a photoconductor drum substrate, characterized in that
in a state in which an outer peripheral surface of an aluminum pipe for a photoconductor drum substrate is in contact with an electrolysis solution, a high- frequency voltage of 5 kHz or higher is applied to the electrolysis solution to conduct electrolysis to thereby form an anodic oxide film on the outer peripheral surface of the aluminum pipe.

2. The method for anodizing an aluminum pipe for a photoconductor drum substrate as recited in claim 1, wherein a negative component voltage of the high-frequency voltage is set to 0V at the time of applying the high-frequency voltage.

3. The method for anodizing an aluminum pipe for a photoconductor drum substrate as recited in claim 2, wherein a negative voltage applied rate calculated by dividing an applied time of the negative component voltage in one cycle by a total cycle time is 0.05 to 0.8 when the high-frequency voltage is applied.

4. The method for anodizing an aluminum pipe for a photoconductor drum substrate as recited in claim 2, wherein the negative component voltage is output using a short-circuit when the high-frequency voltage is applied.

5. The method for anodizing an aluminum pipe for a photoconductor drum substrate as recited in claim 1, wherein an electrolytic waveform of the high-frequency voltage during the electrolysis is a rectangular wave.

6. The method for anodizing an aluminum pipe for a photoconductor drum substrate as recited in claim 1, wherein an electrolysis solution containing at least one of acids selected from the group consisting of sulfuric acid, phosphoric acid, and oxalic acid is used as the electrolysis solution.

7. The method for anodizing an aluminum pipe for a photoconductor drum substrate as recited in claim 1, wherein
the electrolysis is performed by bringing the outer peripheral surface of the aluminum pipe into contact with the electrolysis solution by immersing the aluminum pipe in the electrolysis solution in an electrolytic tank and performing at least one of temperature regulation and concentration regulation of the electrolysis solution in the electrolytic tank.

8. The method for anodizing an aluminum pipe for a photoconductor drum substrate as recited in claim 1, wherein as the aluminum pipe, a pipe made of one of materials selected from the group consisting of Al—Mn series alloy, Al—Mg series alloy, Al—Mg—Si series alloy, and pure aluminum.

9. A photoconductor drum substrate made of an aluminum pipe obtained by anodizing according to the anodizing method as recited in claim 1.

10. The photoconductor drum substrate as recited in claim 9, wherein a relational expression of (T−W)≧50 is satisfied,
where “T” is micro-Vickers hardness MHv of the surface of the aluminum pipe having the anodic oxide film, and “W” is micro-Vickers hardness MHv of the surface of the aluminum pipe having an anodic oxide film formed by conducting electrolysis under the same electrolysis conditions except that direct voltage was applied.
